(19) United States
(12) Patent Application Publication
(10) Pub. No.: US 2025/0100026 A1
(43) Pub. Date: Mar. 27, 2025

(54) SYSTEMS AND ASSOCIATED PROCESSES FOR CLEANING SURFACES

(71) Applicant: Michael Gauvreau, Leesburg, VA (US)

(72) Inventor: Michael Gauvreau, Leesburg, VA (US)

(21) Appl. No.: 18/373,076

(22) Filed: Sep. 26, 2023

(51) Int. Cl. B08B 7/00; B01J 20/12; B08B 1/00; B08B 3/08; B08B 3/10; B08B 7/04; C11D 7/20; C11D 7/50; E01H 1/00

(52) U.S. Cl. CPC B08B 7/0014; B01J 20/12; B08B 1/12; B08B 3/08; B08B 3/102; B08B 7/04; C11D 7/20; C11D 7/5004; E01H 1/001

(57) ABSTRACT

The disclosure provides systems and processes for cleaning a site to remove residue from a surface, of one or more surfaces, on the site. The processes can be performed without the addition of water to the site. A process can include: (A) identifying that the residue is liquid hydrocarbon and/or a hydrocarbon; (B) providing clay-based particulates (CBP) for treatment of the surface; (C) providing biosolvent solution (BSS) for treatment of the surface; (D) applying both (a) the CBP to the surface and (b) the BSS to the surface, in a sequential progression of steps, and such applying including: (a) actively identifying if the surface is wet with hydrocarbon; (b) applying a first sequential progression of steps, of the sequential progression of steps, if the surface is identified as being wet with hydrocarbon, the first sequential progression of steps including application of the CBP without the BSS; and (c) applying a second sequential progression of steps, of the sequential progression of steps, if the surface is identified as being not wet with hydrocarbon, and the second sequential progression of steps including application of the CBP and the BSS.

### BACKGROUND OF THE DISCLOSURE

The disclosure is directed to and relates to systems and associated processes for cleaning surfaces.

More specifically, this disclosure relates to cleaning exterior and interior surfaces, including concrete pads, for example, so as to remove oil-based residue, gasoline based residue, and other hazardous residue from such surfaces.

Many surfaces, both interior and exterior are exposed to oils, gasoline, and other hazardous substances. For example, a gasoline filling station experiences substantial vehicle traffic. Some of the vehicles that come to a gasoline station to refill are indeed leaking oil. Such leaking oil can result from faulty engine gaskets or other deficiencies with the engine. Such leaking oil can fall on a concrete pad, of a filling station, and stain the concrete pad. Over time, a substantial residue can be accumulated that is unsightly and that can cause a health hazard. At a minimum, buildup of oil or gas residue on a concrete slab, for example, can result in an unappealing and “sticky” environment.

Also, at a gasoline filling station, there can be occasional spilling of fuel from persons removing the gasoline nozzle too quickly and/or from other anomalies. While any one occurrence may not be noticeable, over years, such spillage of gasoline can accumulate on a surface and also be unsightly and constitute a health concern. Accordingly, it may well be desirable to clean a concrete pad or other surface so as to remove hazardous residue.

Relatedly, there are products on the market that are designed to clean up gasoline based stains and oil-based stains, for example. Some of these products are in liquid form, while other products are in a granular form. It should be appreciated, some of these products are more effective than others. Further, some of these products are effective for some types of residue, but not for other types of stains. A user may or may not be aware of which products are effective for which residue.

Further, for any given residue, there can be different environmental issues that can relate to how best to clean up such a residue. For example, a concrete pad with oil residue could be free of water and dry. On the other hand, a concrete pad with residue could be routinely wet with water and/or wet with hydrocarbon.

In general, known products on the market fall short of providing an effective system and associated product for cleaning up a variety of oil, gasoline, and other residue, and doing so under different environmental conditions, and on different types of surfaces.

The systems and methods of the disclosure address these deficiencies and others, as described below.

### BRIEF SUMMARY OF THE DISCLOSURE

The disclosure provides systems and processes for cleaning a site to remove residue from a surface, of one or more surfaces, on the site, the process being performed without the addition of water to the site. A process of the disclosure can include (A) identifying that the residue is liquid hydrocarbon and/or a hydrocarbon; (B) providing clay-based particulates (CBP) for treatment of the surface; (C) providing biosolvent solution (BSS) for treatment of the surface; (D) applying both (a) the CBP to the surface and (b) the BSS to the surface, in a sequential progression of steps, and such applying including: (a) actively identifying if the surface is wet with hydrocarbon; (b) applying a first sequential progression of steps, of the sequential progression of steps, if the surface is identified as being wet with hydrocarbon, the first sequential progression of steps including application of the CBP without the BSS; and (c) applying a second sequential progression of steps, of the sequential progression of steps, if the surface is identified as being not wet with hydrocarbon, and the second sequential progression of steps including application of the CBP and the BSS.

### BRIEF DESCRIPTION OF THE DRAWINGS

The present disclosure can be more fully understood by reading the following detailed description together with the accompanying drawings, in which like reference indicators are used to designate like or similar elements, and in which:

FIG. 1 is a schematic diagram of a cleaning site, in accordance with principles of the disclosure, in accordance with principles of the disclosure.

FIG. 2 is a flowchart showing a high-level process to clean residue off of an area stained with a residue, in accordance with principles of the disclosure.

FIG. 3 is a flowchart showing in further detail the process of “perform solution-particulate cleaning method to surface(s) of residue area” of FIG. 2, in accordance with principles of the disclosure.

FIG. 4 is a flowchart showing in further detail the process of “perform solution-particulate, “wet surface cleaning sequence” to wet treatment area” of FIG. 3, in accordance with principles of the disclosure.

FIG. 5 is a flowchart showing in further detail the process of “perform solution-particulate “dry surface cleaning sequence” to surface of dry treatment area” of FIG. 3, in accordance with principles of the disclosure.

FIG. 6 is a diagram showing an example of a clay-based particulates (CBP) that can be use in the systems and processes of the disclosure, in accordance with principles of the disclosure.

FIG. 7 is a diagram showing an example of a biosolvent solution (BSS), that can be use in the systems and processes of the disclosure, in accordance with principles of the disclosure.

### DETAILED DESCRIPTION OF THE DISCLOSURE

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

As used herein, any term in the singular may be interpreted to be in the plural, and alternatively, any term in the plural may be interpreted to be in the singular.

The disclosure provides systems and associated processes for cleaning surfaces. More specifically, the disclosure provides systems and methods, i.e. processes, for effectively cleaning oil-based residue, gasoline based stains, and other hazardous residue from interior and exterior surfaces, such as a concrete pad.

The disclosure provides a multistep process that extracts petrocarbons, hydrocarbons, and other hazardous liquid wastes from interior and exterior surfaces, such as concrete flooring surfaces, in a sustainable and efficient manner. The systems and processes of the disclosure have various positive environmental benefits. Such positive environmental benefits include:
the processes of the disclosure can be performed without the addition of water to an area having residue, i.e., stained area;
the processes of the disclosure can be performed without waste water “runoff” being created;
residues can be safely extracted from concrete and other surfaces;
the processes of the disclosure can be performed without the creation of hazardous waste; and
the components that are used in the processes of the disclosure are non-hazardous.

Other benefits of the disclosure are described herein.

The cleaning system of the disclosure can employ a multi-step process that integrates the use of known substances in a novel and creative manner. In particular, the cleaning system of the disclosure can integrate a clay-based particulate (CBP) product and a biosolvent solution (BSS) in a novel process. The steps of said process can vary based on environmental conditions, such as whether a surface to be cleaned is wet with oil, fuel, or other hydrocarbon or not wet with oil, fuel, or other hydrocarbons.

The clay-based particulates (CBP) can be a product such as, for example, GREENSORB REUSABLE ABSORBENT. The CBP may be and/or may include, for example, montmorillonite. The biosolvent solution (BSS) can be a product such as, for example, SAFEGRADE-320 BIOSOLVENT. The BSS can be water based, in accordance with at least some embodiments of the disclosed subject matter. However, it is appreciated that the disclosure is not limited to such particular products. That is, other clay-based particulate (CBP) product might be utilized, as well as other biosolvent solution (BSS) might be utilized.

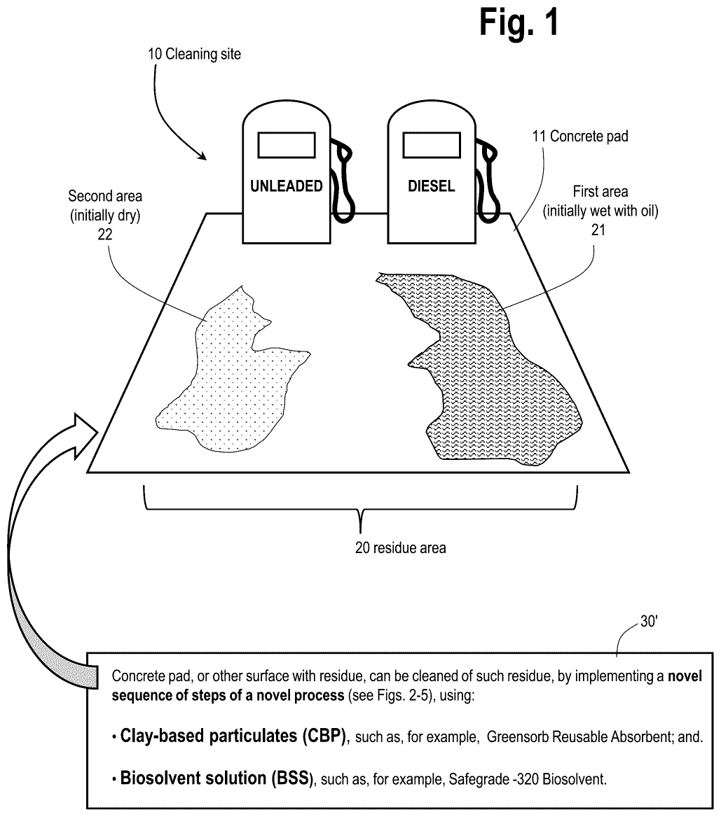

FIG. 1 is a schematic diagram of a cleaning site 10, in accordance with principles of the disclosure. As illustrated, the cleaning site 10 can include a concrete pad 11. However, it is appreciated that the systems and methods of the disclosure are not limited to necessarily concrete. As illustratively shown, the concrete pad 11 can be located at a fuel filling station.

Such a fuel filling station experiences a substantial amount of vehicle traffic, and substantial exposure to potential hazardous spillage and stains.

As illustrated in FIG. 1, the concrete pad 11 can have two different types of stains. There can be a first area 21 that is it stained with residue. Also, there can be a second area 22 that is stained with residue. In this illustrative example, the first area 21 is wet, i.e., is wet with oil. On the other hand, the second area 22 is dry, i.e., without a liquid oil presence on the second area 22. As described below, the systems and methods of the disclosure address the two different areas 21, 22 in a different manner including different process steps for cleaning of such different areas 21, 22. The first area 21 and the second area 22 can be collectively described as a residue area 20, as shown in FIG. 1.

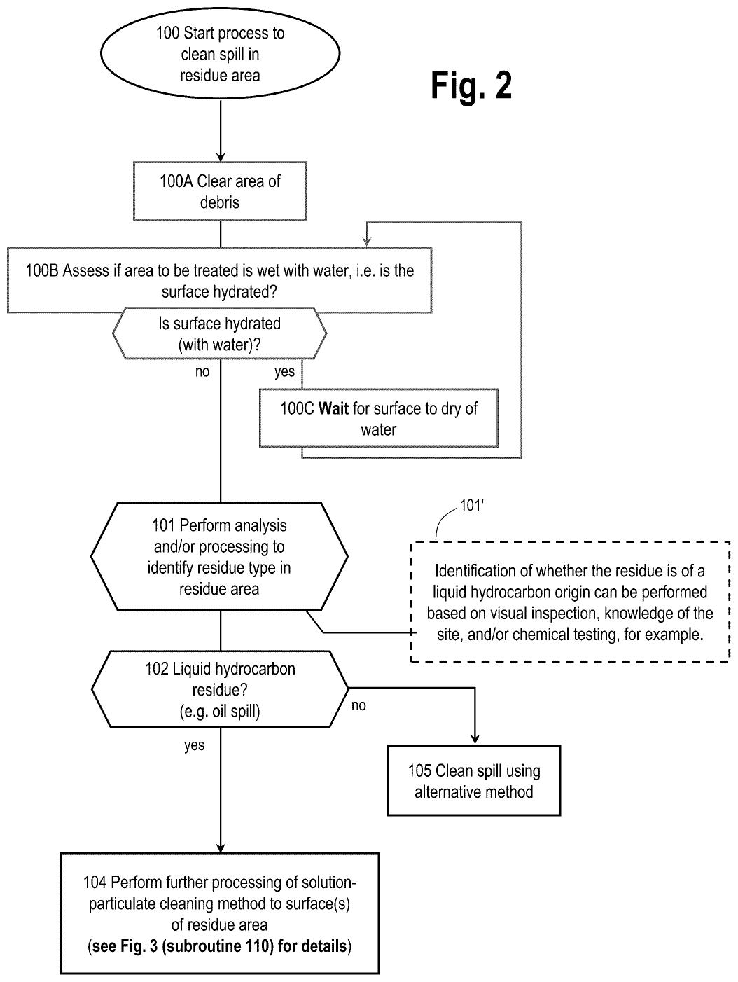

As illustrated at 30′ in FIG. 1, the concrete pad, or other surface with residue, can be cleaned of such residue, by implementing a novel sequence of steps of a novel process. Details of such novel sequence of steps of a novel process are described below with reference to FIGS. 2-5. The systems and methods of the disclosure can effectively combine, in a novel manner, the use of (a) clay-based particulates (CBP), such as, for example, GREENSORB REUSABLE ABSORBENT, and (b) biosolvent solution (BSS), such as, for example, SAFEGRADE-320 BIOSOLVENT.

FIG. 2 is a flowchart showing a high-level process to clean residue off of an area stained with a residue, in accordance with at least one embodiment of the disclosed subject matter. As shown, the process, to clean a spill on a residue area, starts in step 100. The process then passes onto step 100A.

In step 100A, the particular area to be cleaned is cleared of debris. For example, the concrete pad 11 of FIG. 1 might be identified for cleaning using the systems and methods of the disclosure. Accordingly, in step 100A, the concrete pad 11 could be cleaned of debris including physical debris. Such debris might be natural debris such as leaves, stones or rocks; and/or refuse debris such as product wrappers, pieces of receipts, or other remnants. The process of step 100A might be performed using a broom or physically picking up the debris from the area or site to be cleaned. After step 100A, the process passes onto step 100B.

In step 100B, the user assesses whether or not the area to be treated is wet with water, i.e., is the surface “hydrated”? It is appreciated that a surface to be treated may be wet with water, as well as “wet” with oil, fuel, or other hydrocarbon. For purposes of description in the present disclosure, a surface that is wet with water is described herein as being “hydrated”. That is, a hydrated surface is a surface that is wet with water, i.e., wet with H2O. On the other hand, a surface that is “wet” with oil, fuel, or other hydrocarbon is described herein as being simply “wet”.

If, in step 100B, the surface is determined to be hydrated, i.e., wet with water, the process passes to step 100C. In step 100C, the user waits for the surface to be not hydrated, i.e., not wet with water. The user might accelerate such wait time, for example, by using rags to mop up the water and/or by circulating air to dry out the area, such as by using a fan. After a predetermined amount of time, for example 30 minutes, 1 hour, 2 hours, 3 hours, 6 hours, 12 hours, 1 day, or 1 week, the wait time passes by, and the process passes back to step 100B-to determine if the surface is still hydrated.

At a point in time, the assessment of step 100B will render a no, i.e., the area to be treated is no longer hydrated with water, i.e., the area to be treated is no longer wet with water. The process then passes from step 100B on to step 101.

In step 101, an analysis and/or processing is performed so as to identify the residue type in the residue area. As reflected at 101′, identification whether the residue is of a liquid hydrocarbon origin, such as for example a gasoline or oil residue, can be performed based on visual inspection, knowledge of the site (including whether the site has been exposed to oil and gasoline), and/or chemical testing, for example. The systems and methods of the disclosure can be used to clean a variety of hydrocarbons including oil, gasoline, tar, coal, petroleum, natural gas, and/or other types of hydrocarbons.

Accordingly, after the analysis of step 101, the process passes onto step 102. In step 102, a determination is made as to whether the residue is a liquid hydrocarbon residue, such as an oil spill. If “no”, than the process passes onto step 105. In step 105, the user can clean the spill using an alternative method. For example, such alternative method might be soap and water, i.e., in that the residue has been identified as not being hydrocarbon residue.

On the other hand, if a “yes” determination is rendered in step 102, the process passes onto step

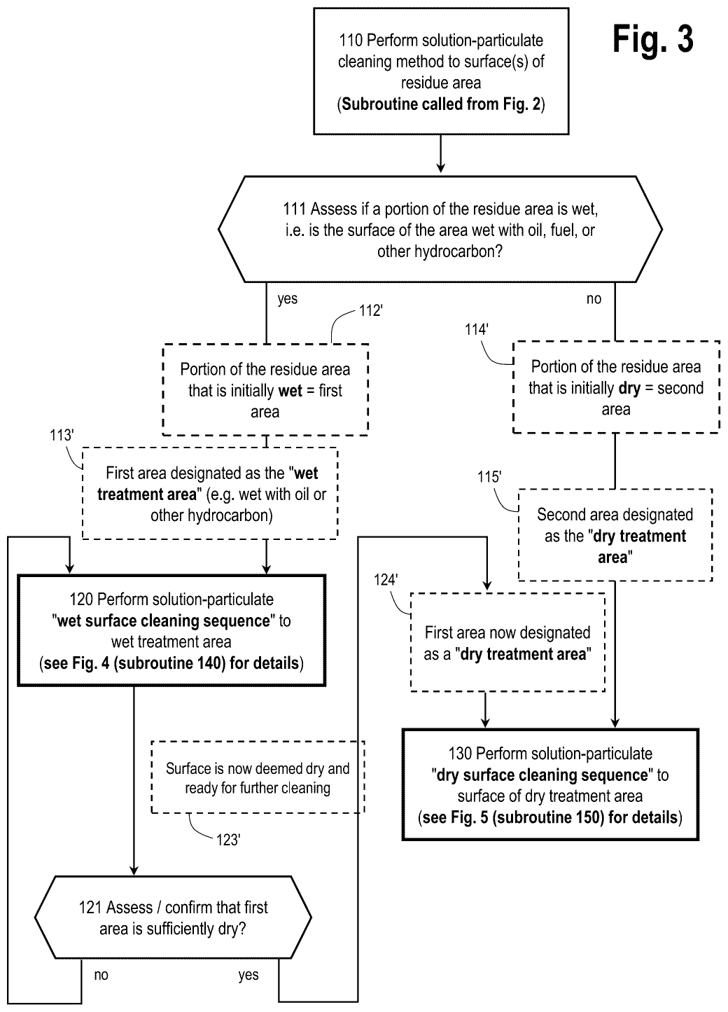

In step 104, further processing of the solution-particulate cleaning method of the disclosure is applied to the concrete pad 11, in this illustrative scenario. FIG. 3 is a flowchart showing such further details, and in particular FIG. 3 shows subroutine 110.

Accordingly, FIG. 3 is a flowchart showing in further detail the process of “perform solution-particulate cleaning method to surface(s) of residue area”, i.e., subroutine 110, of FIG. 2. As shown, the process, i.e., the subroutine 110, is initiated and passes onto step 111. In step 111, a user assesses if a portion of the residue area is wet. That is, a user can assess if a surface or a part of the surface to be cleaned is wet with oil, fuel, or other hydrocarbon. In the example of FIG. 1, a wet area (of the concrete pad 11 for example) that is wet with oil, fuel, or other hydrocarbon can be designated as a first area 21, for purposes of description herein. If a “yes” is rendered in step 111, the process passes onto step 112′.

As noted at 112′ in FIG. 3, the portion of the residue area that is wet, i.e., initially wet, can be designated as a first area. Further, as noted at 113′, such first area can further be designated as the “wet treatment area”, for purposes of description herein.

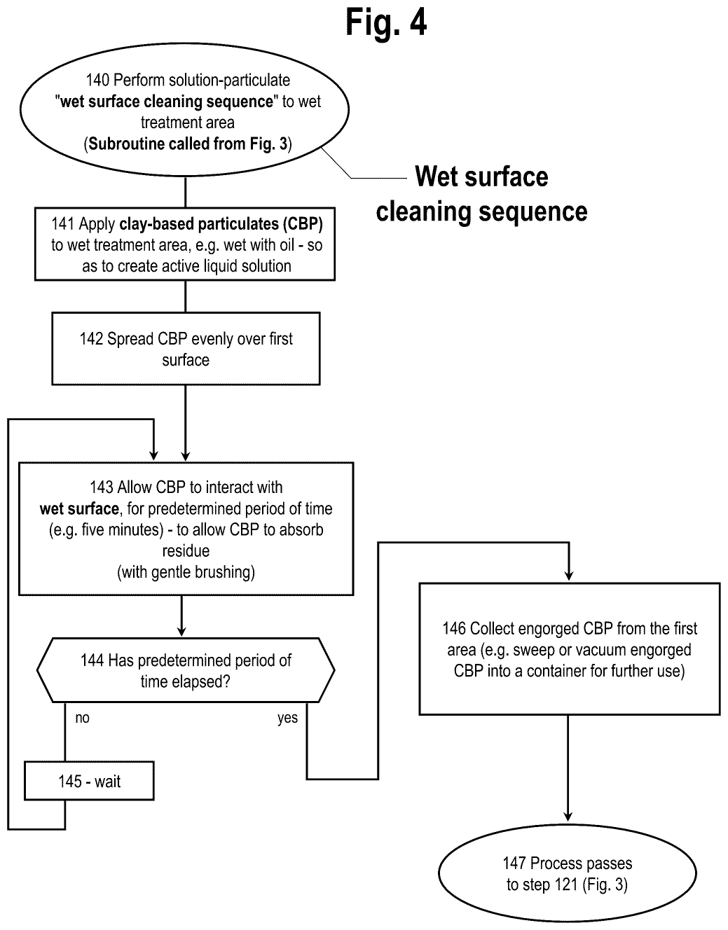

Accordingly, upon a “yes” being rendered in step 111, the process can pass onto step 120, after the designations of step 112′, 113′, in accordance with at least one embodiment of the disclosed subject matter. In step 120, the user can perform a solution-particulate “wet surface cleaning sequence” to the wet treatment area, i.e., to the treatment area that is wet with hydrocarbon, in accordance with principles of the disclosure. Such process, which can be described as a “subroutine”, i.e., subroutine 140, is illustrated in FIG. 4, with details described below with reference to FIG. 4.

After step 120 of FIG. 3, the process passes onto step 121. In step 121, the user assesses and/or confirms that the first area is sufficiently dry. For example, the user assesses whether the first area 21 of the concrete pad 11 (of FIG. 1) is sufficiently dry and/or completely dry. If “no”, then the process passes back to step 120 as shown in FIG. 3. In step 120, the wet surface cleaning sequence can be performed again.

On the other hand, a “yes” can be rendered in step 121. That is, the user might assess that the first area is indeed sufficiently dry and/or completely dry. As reflected at 123′, the surface (in this example the first area) is thus deemed dry and ready for further cleaning. Accordingly, the process passes onto step 124′. In step 124′ the first area is now designated as a dry treatment area, i.e., since such first area is now dry or sufficiently dry and no longer wet with hydrocarbon. The process then passes onto step 130.

With further reference to FIG. 3, the user may assess in step 111 that the surface of the residue area to be cleaned is not wet with oil, fuel, or other hydrocarbon. That is, a no is rendered in step 111. As result, the process passes onto step 114′. In this example, the portion of the residue area that is initially dry, in this example, can be designated as a second area, for purposes of description. Such second area 22 is illustratively shown in the example of FIG. 1. After step 114′ and the designations set forth therein, the process passes onto step 115′. In step 115′, the second area is designated as the dry treatment area. The process then passes onto step 130.

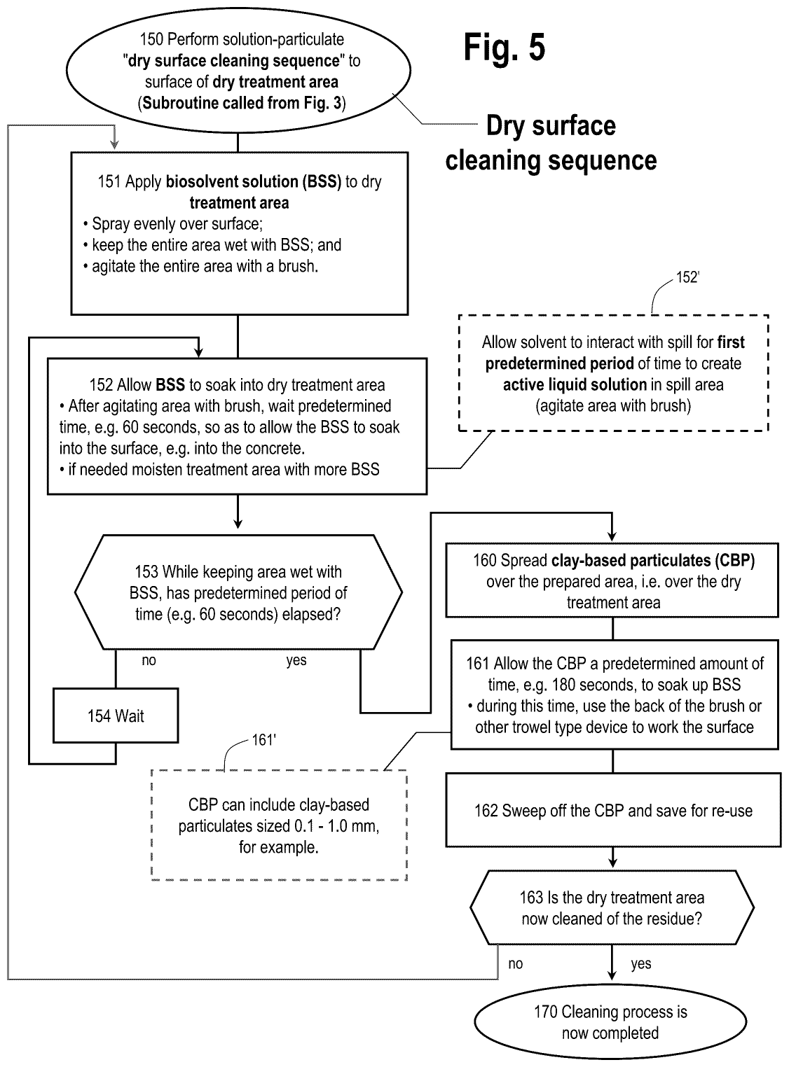

In step 130, the user can perform a solution-particulate “dry surface cleaning sequence” to the dry surface of the treatment area, in accordance with principles of the disclosure. Such process, which can be described as a subroutine, i.e., subroutine 150, is illustrated in FIG. 5, with details described below with reference to FIG. 5.

FIG. 4 is a flowchart showing in further detail the process of “perform solution-particulate “wet surface cleaning sequence” to wet treatment area” of FIG. 3, in accordance with principles of the disclosure.

As shown, the process, i.e., subroutine 140, is initiated and passes onto step 141. In step 141, the user can apply clay-based particulates (CBP) to the wet treatment area, i.e., in this example the first area 21 (as shown in FIG. 1). CBP can be applied to the wet treatment area, i.e., the first area 21, so as to create an active liquid solution. The user, in step 142, can spread the CBP evenly over the first surface of the first area 21. Then, the process passes onto step 143. In step 143, the user can allow the CBP to interact with the wet surface for a predetermined period of time. For example, such predetermined period of time might be 5 minutes. It is appreciated that the particular period of time, in step 143, can depend on the particular CBP that is being utilized.

In step 143, the predetermined period of time can allow the CBP to absorb the residue in the first area. Such absorption of the residue can be assisted by the user gently brushing or otherwise “working in” the CBP into the first area 21. The determination of step 144 reflects a decision point of whether the predetermined period of time has or has not elapsed. If no, then in step 145, the user further waits till the predetermined period of time has been attained. Accordingly, as shown in FIG. 4, the process loops back to step 143.

On the other hand, at a point in time, the user will determine that indeed the predetermined period of time has elapsed, i.e., a “yes” is rendered in step 144. As result, the process passes from step 144 onto step 146. In step 146, the user can collect the engorged or partially engorged CBP from the first area. For example, the user might sweep or vacuum the engorged CBP into a container for further use. In such processing, it is appreciated that a vacuum unit and/or container can be “dedicated” to the collection of the CBP. That is, such a vacuum unit and/or container can be free of other contaminants so as not to contaminate the collected CBP. As result, the collected CBP can be used for future use, at least for a lifespan of the CBP.

After step 146, the process passes on to step 147. In step 147, the process passes back to FIG. 3, i.e., the process passes to step 121 of FIG. 3.

FIG. 5 is a flowchart showing in further detail the process of performing solution-particulate “dry surface cleaning sequence” to the surface of the “dry treatment area” of FIG. 3, subroutine 150, in accordance with principles of the disclosure. As shown, the process of subroutine 150 is initiated and passes onto step 151.

In step 151, a user can apply a biosolvent solution (BSS) to the dry treatment area. The user can spray the BSS evenly over the surface to be treated. For a predetermined period of time, the entire area of the surface to be treated can be kept wet with BSS. During such time, the user can agitate the area with a brush or other agitation device.

As reflected at 152′, in FIG. 5, the user can allow the solvent to interact with the spill or residue for what can be described as a first predetermined period of time in the process of subroutine 150. In this first predetermined period of time, the solvent, i.e. the BSS, can be allowed to interact with the spill so as to create an active liquid solution in the spill area. Relatedly, in step 152, the user can allow the BSS to soak into the dry treatment area. After the user agitates the area with a brush, the user can wait a predetermined period of time so as to allow the BSS to soak into the surface. For example, so as to allow time for the BSS to soak into the concrete. In this time, if needed, the user can moisten the treatment area with more BSS. In this example, the predetermined period of time is 60 seconds, for example. However, it is appreciated that with other BSS, the predetermined period of time might be different.

With further reference to FIG. 5, in step 153, while keeping the area wet with BSS, the user assesses whether the predetermined period of time has elapsed. If “no”, then the user waits, in step 154, the process loops back to step 152.

On the other hand, at a point in time, the predetermined period of time will have elapsed. As result, a “yes” will be rendered in step 153. Accordingly, the process can pass from step 153 onto step 160. In step 160, the user can then spread clay-based particulates (CBP) over the prepared area, i.e., over the dry treatment area. Then, the process passes onto step 161.

In step 161, the user can allow the CBP a predetermined amount of time to soak up the BSS. For example, the predetermined period of time might be 3 minutes or 180 seconds. During this time, the user can use the back of a brush or other trowel type device so as to “work” the surface. Then, the process passes onto step 162. In step 162, the user can sweep up, or otherwise recover, the CBP and save for future use. Then, the process passes onto step 163. In step 163, the user can assess whether the dry treatment area, i.e., the area that has just been treated, is now cleaned (or sufficiently cleaned) of the residue.

If a “no” is rendered in step 163, then the process passes back to step 151. In step 151, the process as described above, with reference to FIG. 5, can be repeated.

On the other hand, if a “yes” is rendered in step 163, the process passes onto step 170. In step 170, the cleaning process is now completed.

As noted in FIG. 5 at 161′ CBP can include clay-based particulates sized 0.1-1.0 mm (millimeter), for example. However, other sized particulate may also be used. The particular size of particulates used may vary dependent on the particular application, environment, cost consideration, time requirements, desired reusability, and other factors. For example, larger particulates may absorb substances more quickly (as compared to a smaller particulate), but retain substances to a greater degree, and accordingly, be less conducive to re reusability.

Accordingly, various features of the systems and methods of the disclosure have been described above. The disclosure provides a multistep process, i.e., a multistep method, that includes the application of both CBP and BSS. The disclosure provides a novel methodology that can be applied to different hydrocarbons, for example, in both dry and wet situations.

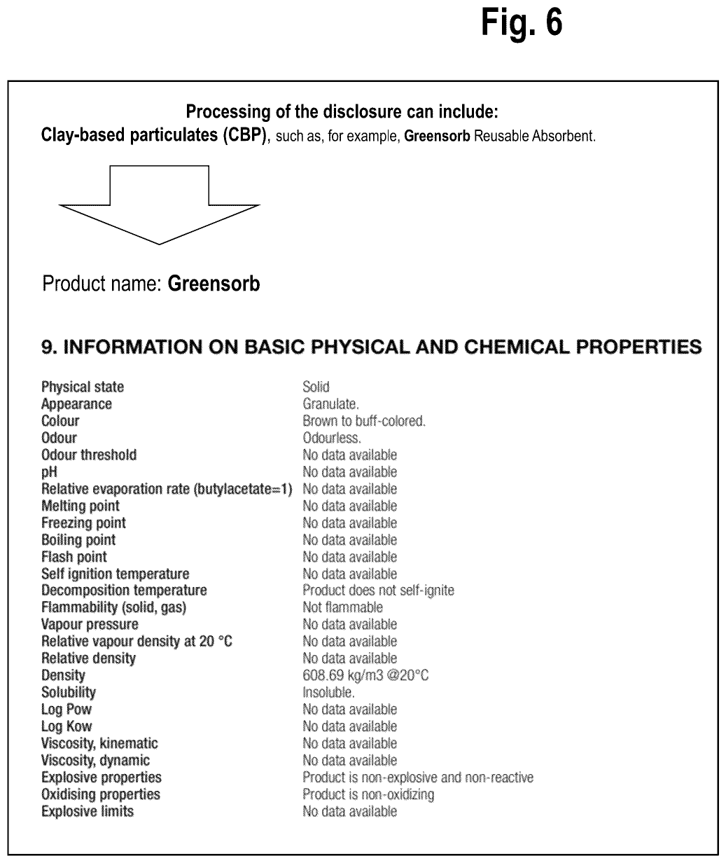

FIG. 6 is a diagram showing an example of a clay-based particulates (CBP) that can be use in the systems and processes of the disclosure, in accordance with principles of the disclosure. That is, FIG. 6 shows properties of “GREENSORB REUSABLE ABSORBENT” that can be used in accordance with principles of the disclosure.

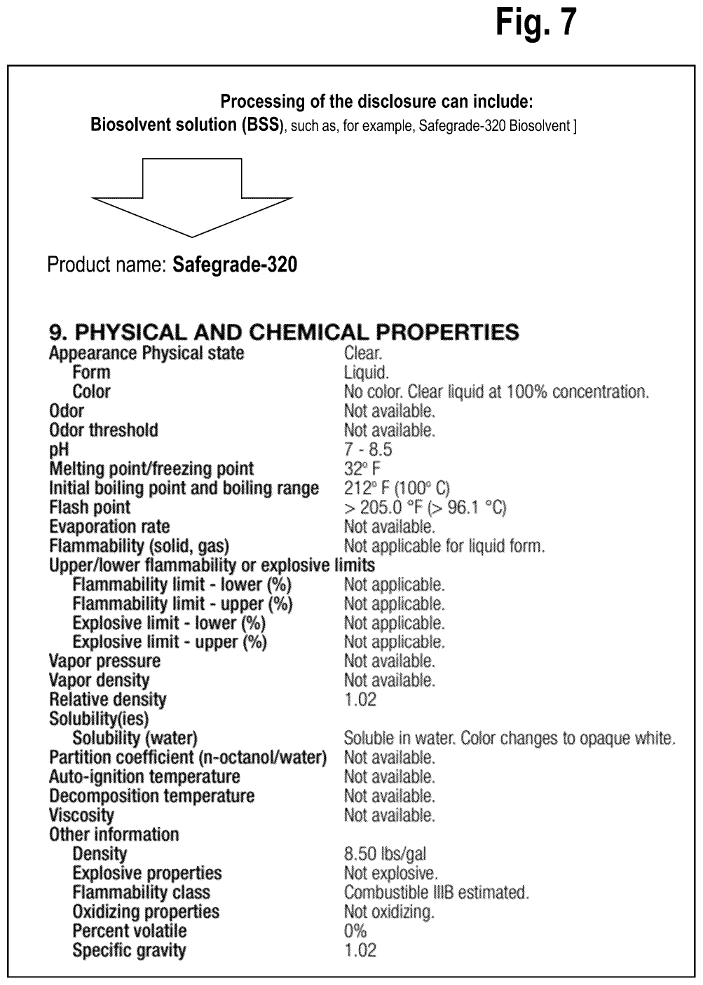

FIG. 7 is a diagram showing an example of a biosolvent solution (BSS), that can be use in the systems and processes of the disclosure, in accordance with principles of the disclosure. That is, FIG. 7 shows properties of “SAFEGRADE-320 BIOSOLVENT” that can be used in accordance with principles of the disclosure.

It is appreciated that various embodiments are described herein. It is appreciated that a particular feature of a particular embodiment described herein might be utilized in other embodiments described herein, as desired.

It will be appreciated that features, elements and/or characteristics described with respect to one embodiment of the disclosure may be variously used and combined with other embodiments of the disclosure as may be desired.

In this disclosure, quotation marks, such as with “treatment area”, have been used to enhance readability and/or to parse out a term or phrase for clarity.

It is appreciated that the effects of the present disclosure are not limited to the above-mentioned effects, and other effects, which are not mentioned herein, will be apparent to those in the art from the disclosure and accompanying claims.

Although the preferred embodiments of the present disclosure have been disclosed for illustrative purposes, those skilled in the art will appreciate that various modifications, additions and substitutions are possible, without departing from the scope and spirit of the disclosure and accompanying claims.

As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present disclosure.

Spatially relative terms, such as “lower”, “upper”, “top”, “bottom”, “left”, “right”, “forward”, “back”, “inner”, “outer” and the like, may be used herein for ease of description to describe the relationship of one element or feature to another element(s) or feature(s) as illustrated in the drawing figures. It will be understood that spatially relative terms are intended to encompass different orientations of structures in use or operation, in addition to the orientation depicted in the drawing figures. For example, if a depiction in the drawing figures is turned over, elements described as “lower” relative to other elements or features would then be oriented “upper” relative the other elements or features. Thus, the exemplary term “lower” can encompass both an orientation of above and below. The device may be otherwise oriented (rotated 90 degrees or at other orientations) and the spatially relative descriptors used herein should be interpreted accordingly.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the disclosure. The appearances of such phrases in various places in the specification are not necessarily all referring to the same embodiment. Further, as otherwise noted herein, when a particular feature, structure, or characteristic is described in connection with any embodiment, it is submitted that it is within the purview of one skilled in the art to effect and/or use such feature, structure, or characteristic in connection with other ones of the embodiments.

While the subject matter has been described in detail with reference to exemplary embodiments thereof, it will be apparent to one skilled in the art that various changes can be made, and equivalents employed, without departing from the scope of the disclosure.

All related art references discussed in the above Background section are hereby incorporated by reference in their entirety. All documents referenced herein are hereby incorporated by reference in their entirety.

In conclusion, it will be readily understood by those persons skilled in the art that the present disclosure is susceptible to broad utility and application. Many embodiments and adaptations of the present disclosure other than those herein described, as well as many variations, modifications and equivalent arrangements, will be apparent from or reasonably suggested by the present disclosure and foregoing description thereof, without departing from the substance or scope of the disclosure.

Accordingly, while the present disclosure has been described here in detail in relation to its exemplary embodiments, it is to be understood that this disclosure is only illustrative and exemplary of the present disclosure and is made to provide an enabling disclosure of the disclosure. Accordingly, the foregoing disclosure is not intended to be construed or to limit the present disclosure or otherwise to exclude any other such embodiments, adaptations, variations, modifications and equivalent arrangements.

What is claimed is:

1. A process for cleaning a site to remove residue from a surface, of one or more surfaces, on the site, the process being performed without the addition of water to the site, the process including:
identifying that the residue is liquid hydrocarbon and/or a hydrocarbon;
providing clay-based particulates (CBP) for treatment of the surface;
providing biosolvent solution (BSS) for treatment of the surface;
applying both (a) the CBP to the surface and (b) the BSS to the surface, in a sequential progression of steps, and such applying including:
actively identifying if the surface is wet with hydrocarbon;
applying a first sequential progression of steps, of the sequential progression of steps, if the surface is identified as being wet with hydrocarbon,
the first sequential progression of steps including application of the CBP without the BSS; and
applying a second sequential progression of steps, of the sequential progression of steps, if the surface is identified as being not wet with hydrocarbon, and
the second sequential progression of steps including application of the CBP and the BSS.

2. The process of claim 1, the process including:
identifying that the surface is wet with hydrocarbon;
applying the first sequential progression of steps, the first sequential progression of steps constituting a wet surface cleaning sequence, including:
applying the CBP to the surface;
spreading the CBP over the surface;
allowing the CBP to interact with the surface, which is wet with hydrocarbon; and
collecting the CBP that has absorbed the water.

3. The process of claim 2, the process further including, after collecting the CBP, assessing whether the surface is now dry, and:
if the surface is still wet, again applying the first sequential progression of steps, and
if the surface is now dry, applying the second sequential progression of steps.

4. The process of claim 2, the CBP is GREENSORB.

5. The process of claim 1, the process including the steps of, in order:
identifying that the surface is not wet with hydrocarbon;
applying the second sequential progression of steps, the second sequential progression of steps constituting a dry surface cleaning sequence, including:
applying the BSS to the surface by spraying;
allowing the BSS to interact with the surface while agitating the surface with an agitation device, such as a broom;
waiting a first predetermined amount of time;
spreading CBP over the surface;
waiting a second predetermined amount of time so as to allow the CBP to soak up the BSS; and
sweeping the CBP off of the surface.

6. The process of claim 5, the first predetermined amount of time is 60 seconds.

7. The process of claim 5, the second predetermined amount of time is 180 seconds.

8. The process of claim 5, the process further including, after the sweeping the CBP off of the surface:
collecting the CBP for re-use.

9. The process of claim 5, the CBP is GREENSORB, and the BSS is SAFEGRADE-320.

10. The process of claim 1, the CBP is GREENSORB.

11. The process of claim 1, the BSS is SAFEGRADE-320.

12. The process of claim 7, the CBP is GREENSORB.
